(19) United States
(12) Patent Application Publication
(10) Pub. No.: US 2022/0172503 A1
(43) Pub. Date: Jun. 2, 2022

(54) METHOD FOR MONITORING A PASSENGER COMPARTMENT

(71) Applicant: Robert Bosch GmbH, Stuttgart (DE)

(72) Inventors: Laura Heubeck, Ruegland (DE); Henning Hoepfner, Renningen (DE); Tobias Meilinger, Tuebingen (DE)

(21) Appl. No.: 17/456,128

(22) Filed: Nov. 22, 2021

(30) Foreign Application Priority Data
Nov. 27, 2020 (DE) 10 2020 214 910.0

(51) Int. Cl. G06V 40/10; G06V 40/20; G06V 10/10; G06T 7/73; B60W 40/08

(52) U.S. Cl. CPC G06V 40/103; G06V 40/20; G06V 10/16; G06T 7/75; B60W 40/08; B60W 2556/45; G06T 2207/30268; B60W 2040/0881; B60W 2540/221; B60W 2540/227; G06T 2207/30196

(57) ABSTRACT

A method for monitoring a passenger compartment. The method includes: monitoring a passenger compartment and recognizing a vehicle occupant with the aid of a monitoring device, determining an abstracted model of the vehicle occupant based on data of the monitoring device, detecting a critical situation in the passenger compartment, taking one or more snapshots of the critical situation utilizing the monitoring device, transmitting the abstracted model of the vehicle occupant and the one or more snapshots to a server and/or storing the abstracted model of the vehicle occupant and the one or more snapshots in a storage unit and/or initiating a defined action.

### CROSS REFERENCE

The present application claims the benefit under 35 U.S.C. § 119 of German Patent Application No. DE 102020214910.0 filed on Nov. 27, 2020, which is expressly incorporated herein by reference in its entirety.

### BACKGROUND INFORMATION

German Patent Application No. DE 10 2014 214 352 A1 describes a method and system for operating an occupant-monitoring system.

U.S. Pat. No. 9,224,278 B2 describes a method for detecting a lit cigarette.

### SUMMARY

In accordance with an example embodiment of the present invention, a method is provided for monitoring a passenger compartment, having the steps of:

Monitoring a passenger compartment and recognizing a vehicle occupant with the aid of a monitoring device,

Determining an abstracted model of the vehicle occupant based on data of the monitoring device,

Detecting a critical situation in the passenger compartment,

Taking one or more snapshots of the critical situation utilizing the monitoring device,

Transmitting the abstracted model of the vehicle occupant and the one or more snapshots to a server and/or storing the abstracted model of the vehicle occupant and the one or more snapshots in a storage unit and/or initiating a defined action.

The monitoring device may also be referred to as monitoring system, driver-monitoring system and/or occupant-monitoring system. For example, the monitoring device may be designed to monitor the passenger compartment, particularly one or more vehicle occupants, e.g., a body posture, a viewing direction and/or a position of a head or of a face or of eyes of the vehicle occupant, especially of a driver and/or a front-seat passenger and/or one or more vehicle occupants in the rear seat, or to detect the state of drowsiness and/or other vital values of the one or more vehicle occupants. In addition, an identity of a vehicle occupant may be determined, for example.

An advantage of the present invention lies in the fact that critical situations may be detected reliably and/or easily and, in particular, measures may be initiated and/or relevant means of evidence may be stored. In particular, by using an abstracted model of a vehicle occupant, it is possible to reduce a volume of data for storage and/or for transmission. Due to this, the data, that is, the volume of data may be transmitted and/or stored more quickly and with lower expenditure, e.g., lower costs. In addition, notably, personal information is able to be sensed. Above all, the comfort of the vehicle occupants may thereby be increased. Specifically, by utilizing snapshots, situations are able to be assessed or evaluated better, and in particular, means of evidence may be stored. As a result, namely, a critical situation may be reliably detected and, in particular, may be stored. Moreover, by utilizing snapshots, the volume of data to be transmitted and/or stored may be reduced.

In one advantageous implementation of the present invention, a critical situation may be smoking in the passenger compartment, a situation injurious to health for one or more vehicle occupants, violence between two or more vehicle occupants and/or stealing of one or more articles in the passenger compartment. By detecting a corresponding critical situation, suitable measures may be initiated specifically in order, namely, to de-escalate a situation or to provide assistance to certain vehicle occupants. Above all, the comfort and/or safety of the vehicle occupants may thereby be improved.

In one further development of the present invention, the one or more vehicle occupants and/or one or more articles in the passenger compartment may be classified as different objects with the aid of an object classification. Consequently, a critical situation may be recognized especially easily and/or reliably, so that above all, the safety and/or the comfort of the vehicle occupants may be improved. Moreover, notably, the evaluation of the data provided may be facilitated by an object classification. In particular, it is thereby possible to save on or reduce expenditure, e.g., time and/or costs, for the evaluation.

In one exemplary embodiment of the present invention, the one or more vehicle occupants and/or the one or more articles in the passenger compartment may be localized by the use of the monitoring device. Preferably, a position area of the one or more vehicle occupants and/or of the one or more articles in the passenger compartment may be identified. Consequently, a critical situation may be recognized especially easily and/or reliably, whereby above all, the safety and/or the comfort of the vehicle occupants may be improved. Moreover, notably, the evaluation of the data provided may be facilitated by the localization of the objects. In particular, it is thereby possible to save on expenditure, e.g., time and/or costs, for the evaluation.

In addition, the one or more snapshots may be taken when the position areas of the one or more vehicle occupants and/or of the one or more articles in the passenger compartment at least partially overlap. For example, the one or more snapshots may be taken specifically when the position areas of the one or more vehicle occupants and/or of the one or more articles in the passenger compartment overlap by a percentage of at least 30%, especially at least 50%. By recognizing an overlap, a critical situation may be detected especially safely and/or reliably. Notably, the snapshots may be taken specifically at advantageous or optimized moments or points in time in order, e.g., to permit particularly reliable documenting and storing of the critical situation.

Moreover, an apparatus is provided for monitoring a passenger compartment. In accordance with an example embodiment of the present invention, the apparatus has a monitoring device, the apparatus being designed to carry out a method for monitoring a passenger compartment. An advantage of the apparatus lies in the fact that a critical situation is detected particularly safely and/or reliably, so that above all, the comfort and/or the safety in the passenger compartment may be increased. Furthermore, by using an abstracted model in combination with snapshots, the volume of data to be transmitted and/or stored may be reduced. Due to this, expenditure, e.g., time and/or costs, may be reduced.

### BRIEF DESCRIPTION OF THE DRAWINGS

Exemplary embodiments of the present invention are represented in the figures and explained in greater detail in the following description. Identical reference numerals are used for the elements, shown in the various figures, that are similarly acting, a repeated description of the elements being omitted.

FIG. 1 shows a schematic representation of a vehicle having an apparatus for monitoring a passenger compartment utilizing a monitoring device according to one exemplary embodiment of the present invention.

FIG. 2 shows a schematic representation of a method according to one exemplary embodiment of the present invention.

FIG. 3 shows a schematic representation of a vehicle with an abstracted model of a vehicle occupant according to one exemplary embodiment of the present invention.

FIG. 4 shows a schematic representation of a snapshot of a passenger compartment according to one exemplary embodiment of the present invention.

FIG. 5 shows a schematic representation of a snapshot of a passenger compartment according to one exemplary embodiment of the present invention.

FIG. 6 shows a schematic representation of a snapshot of a vehicle occupant according to one exemplary embodiment of the present invention.

### DETAILED DESCRIPTION OF EXAMPLE EMBODIMENTS

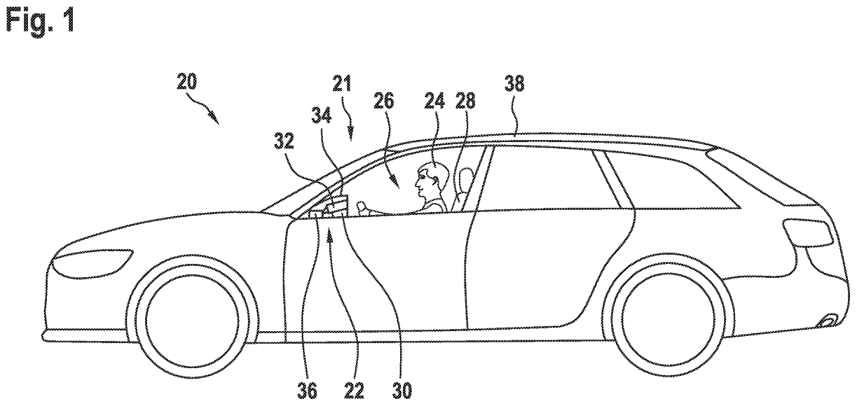

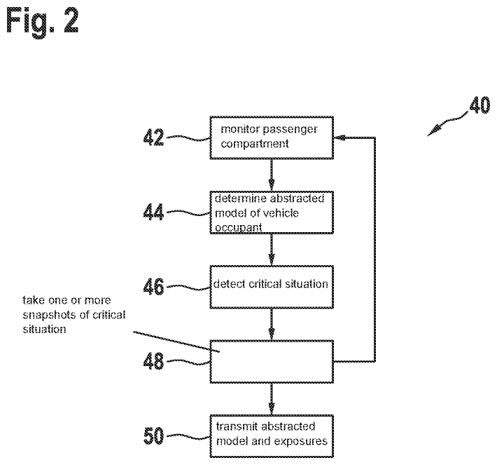

FIG. 1 shows a schematic representation of a vehicle 20, for example, a motor vehicle, e.g., an automobile, having an apparatus 21 for monitoring a passenger compartment 26 utilizing a monitoring device 22. Apparatus 21 is designed to carry out a method according to FIG. 2. Monitoring device 22 is designed to monitor a vehicle occupant 24. Namely, vehicle 20 has a passenger compartment 26 or interior 26, it being possible especially for one or more seats 28 for one or more vehicle occupants 24 to be disposed in passenger compartment 26. In addition, vehicle 20 has a monitoring device 22 for monitoring passenger compartment 26 and/or a vehicle occupant 24, monitoring device 22 also being able to be referred to as monitoring system and/or as occupant-monitoring system. For example, monitoring device 22 may be designed to detect a viewing direction, a body posture and/or the position of the head or the face or the eyes of vehicle occupant 24 or the state of drowsiness and/or other vital values of vehicle occupant 24. In addition, an identity of vehicle occupant 24 may be detected, for example.

To monitor vehicle occupant 24, monitoring device 22 has an illumination unit 30 for emitting rays of light, especially infrared rays, and a recording unit 32. Monitoring device 22 may be mounted particularly in a dashboard 34 and/or in an instrument panel 34 of vehicle 20. In one advantageous development, monitoring device 22 may be mounted especially in an instrument cluster in dashboard 34. Alternatively or additionally, monitoring device 22 may also be mounted at a different location in passenger compartment 26 of vehicle 20, for example, on a vehicle roof 38, on a rearview mirror, a back of a vehicle seat 28 or on a pillar of vehicle 20, e.g., on the A-pillar and/or the B-pillar.

Illumination unit 30 is aimed particularly in the direction of one or more vehicle seats 28 and thus in the direction of vehicle occupant 24, in order to shine rays of light, especially infrared rays, on vehicle occupant 24. In other words, rays of light, particularly infrared rays, are emitted in the direction of vehicle occupant 24 by illumination unit 30. For example, illumination unit 30 may take the form of a light unit, light element, luminescence diode, LED, OLED and/or laser diode or may have a light unit, a light element, a luminescence diode, an LED, OLED and/or a laser diode.

For example, recording unit 32 may take the form of an image-recording unit, e.g., a sensor or camera, especially an infrared camera module, recording unit 32 being aimed in the direction of vehicle occupant 24 and therefore in the direction of vehicle seat 28, in order to visually record vehicle occupant 24 of vehicle 20. Due to the implementation as an infrared camera module, it is possible to monitor at night, as well, without a light shining brightly on vehicle occupant 24 and thereby blinding him/her.

Put another way, monitoring device 22 is designed to monitor a passenger compartment of a vehicle. Monitoring device 22 has an illumination unit 30 for emitting rays of light, especially infrared rays, in the direction of the passenger compartment, and a recording unit 32 for picking up rays of light, particularly infrared rays, the rays of light, especially infrared rays, emitted by illumination unit 30 being reflectable at or in the passenger compartment and the reflected rays of light, especially infrared rays, being steerable in the direction of recording unit 32.

In addition, monitoring device 22 has a control unit 36 or an evaluation unit 36 or an arithmetic logic unit 36 for controlling illumination unit 30 and/or recording unit 32 and/or for processing the data recorded with the aid of recording unit 32.

In other words, passenger compartment 26 may be monitored and a vehicle occupant 24 may be recognized with the aid of apparatus 21 having the monitoring device. In particular, the data recorded may be evaluated utilizing arithmetic logic unit 36. For example, by using arithmetic logic unit 36, an abstracted model of vehicle occupant 24 may be determined based on data of monitoring device 22. In addition, a critical situation in passenger compartment 26 may be detected utilizing arithmetic logic unit 36. In an alternative specific embodiment, additionally or alternatively, the critical situation may be determined on an external server. Moreover, one or more snapshots of the critical situation are taken with the aid of monitoring device 22. For instance, the snapshots may be taken as photographs and thus as image representations. Alternatively or additionally, short film sequences may be recorded.

The abstracted model of vehicle occupant 24 and the one or more snapshots may be transmitted to a server, particularly an external server. For this, arithmetic logic unit 36 may have a transmitting unit, for example, or may be connected to a transmitting unit. Alternatively or additionally, the abstracted model of vehicle occupant 24 and the one or more snapshots may be stored in a storage unit, e.g., of arithmetic logic unit 36.

Alternatively or additionally, upon detection of a critical situation, a defined action may be initiated.

Put another way, with the aid of an object classification and localization of articles in the image, utilizing a local arithmetic logic unit in vehicle 20, a suitable snapshot or a suitable image may be selected for transmission. To that end, one simple condition may be set: For example, that the classified objects—vehicle occupant or face of the vehicle occupant and one article, e.g., a cigarette—at least partially overlap each other in the image. From this, a suitable evidential image may be obtained, whereby detection of a critical situation and/or, in one further development, also a measurement by a particle sensor, for example, are plausibilized

Moreover, initially one possible image may also be held in an intermediate memory and replaced as soon as a more suitable image is recognized. For example, a combination of certainty of the object classification, size of the objects and distance between the objects is possible here as quality criterion. To that end, size and distance may be suitably normalized and summed up with the classification certainty, e.g., with a value between 0 and 1, as close to 1 as possible.

In one further development, for example, a short image sequence of the snapshots in which the situation in passenger compartment 26 changes may be recorded, in the course of which, an article which belongs to vehicle 20 draws closer to a pocket or a backpack, for instance, and disappears. It is then possible or probable that the article is now in the pocket or backpack, namely, of a vehicle occupant 24. If vehicle occupant 24 having the pocket now leaves vehicle 20, it must be assumed that the article belonging to the vehicle has also left vehicle 20 and thus has possibly been stolen. The reverse process is possible, when objects are forgotten in the vehicle; for this, a detection in accordance with the wishes of the user may be facilitated, as well.

Further scenarios may be, for example, that a vehicle occupant 24 having an article gets into vehicle 20 and leaves the vehicle again without the article. Furthermore, it is possible to detect if, for example, during the drive and thus while a vehicle occupant is driving, a cell phone is being held close to the head of the vehicle occupant. Moreover, in particular, prohibited articles, e.g., cigarettes, weapons and/or drugs in passenger compartment 26 are able to be detected. In addition, violent actions are able to be detected, for example, if two or more vehicle occupants 24 move with rapid motions and their positions or position areas repeatedly overlap.

FIG. 2 shows a schematic representation of a method 40 for monitoring a passenger compartment according to one exemplary embodiment of the present invention. For example, the passenger compartment may be the passenger compartment of a vehicle according to FIG. 1. Method 40 may be carried out, e.g., with the aid of an apparatus according to the apparatus as per FIG. 1.

In a first step 42 of method 40, a passenger compartment is monitored with the aid of a monitoring device. For example, the monitoring device may be designed according to the monitoring device as per FIG. 1 and/or may be disposed in a vehicle. In addition, a vehicle occupant may be detected by the monitoring device.

In one advantageous development, the one or more vehicle occupants and/or one or more articles in the passenger compartment may be classified as different objects with the aid of an object classification. Put another way, a vehicle occupant and/or articles may be defined as objects of a specific category. For example, vehicle occupants and/or articles may thus be divided into a certain class or category.

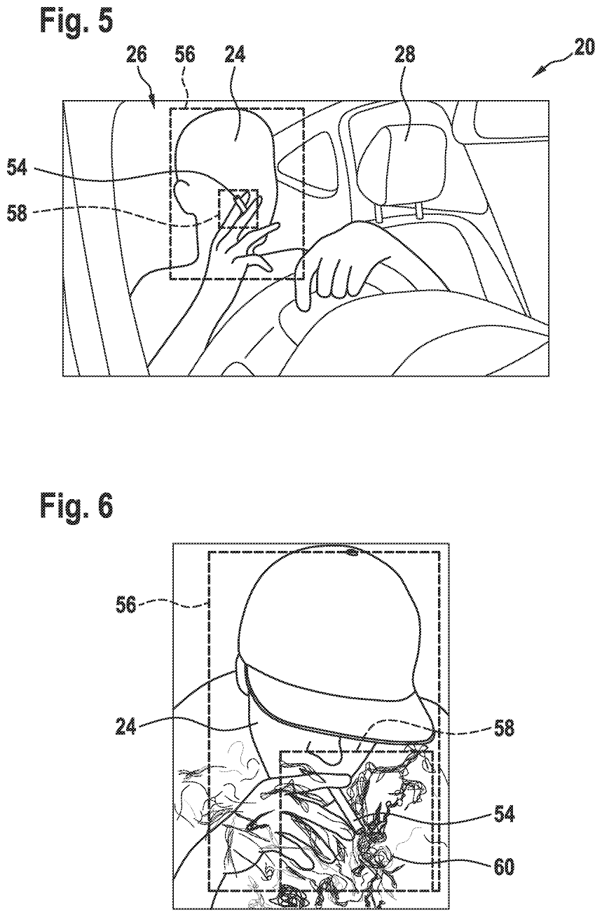

Moreover, the one or more vehicle occupants and or the one or more articles in the passenger compartment may be localized utilizing the monitoring device. For example, a position area of the one or more vehicle occupants and/or of the one or more articles in the passenger compartment may be identified. In other words, vehicle occupants and/or articles may be localized in such a way that a position area may be assigned to them. For example, a position area may be marked in a shot taken by the monitoring device, particularly according to FIG. 4, FIG. 5 and/or FIG. 6.

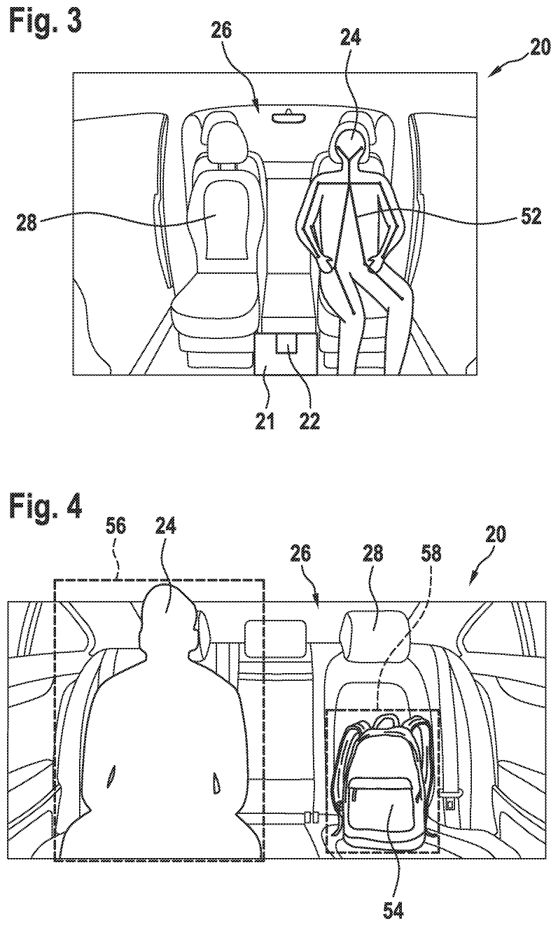

In a second step 44 of method 40, an abstracted model of the vehicle occupant is determined based on data of the monitoring device, especially based on the data recorded in first step 42 by the monitoring of the vehicle occupant. For example, the abstracted model may be determined utilizing an arithmetic logic unit and a suitable algorithm, e.g., an abstraction algorithm or abstracting algorithm. The abstracted model may be formed particularly according to FIG. 3.

In a third step 46 of method 40, a critical situation is detected in the passenger compartment. A critical situation may be, for example, smoking in the passenger compartment, a situation injurious to health for one or more vehicle occupants, violence between two or more vehicle occupants and/or stealing of one or more articles in the passenger compartment.

For example, a critical situation may be detected with the aid of a defined algorithm. For further evaluation and to back up the algorithm, a critical situation may be detected preferably when a critical situation is recognized with the aid of the algorithm and when the position areas of the one or more vehicle occupants and or of the one or more articles in the passenger compartment at least partially overlap. By preference, a critical situation may be detected when a critical situation is recognized with the aid of the algorithm and when the position areas of the one or more vehicle occupants and/or of the one or more articles in the passenger compartment overlap by a percentage of at least 30%, especially at least 50%.

In a fourth step 48 of method 40, one or more snapshots of the critical situation is/are taken by the monitoring device. The one or more snapshots may be taken preferably when the position areas of the one or more vehicle occupants and/or of the one or more articles in the passenger compartment at least partially overlap. In a further development, the one or more snapshots may be taken when the position areas of the one or more vehicle occupants and/or of the one or more articles in the passenger compartment overlap by a percentage of at least 30%, especially at least 50%.

If no critical situation is detected, method 40 may return specifically to first step 42 and thus, namely, to the monitoring of the passenger compartment.

In a fifth step 50 of method 40, the abstracted model of the vehicle occupant and the one or more snapshots are transmitted to a server and/or stored, e.g., in a storage unit of the vehicle and/or of an external server, and/or a defined action is initiated.

The volume of data to be transmitted for raw data of a full HD video with the pixel count 1920×1080 for, e.g., 24 images per second with three color channels may amount approximately to between 0.5 and 1.5 Gbit/s, for example, especially approximately 1 Gbit/s. The volume of data to be transmitted for a compressed video with a lossy compression and low quality may amount approximately to between 0.5 and 1.5 Mbit/s, for example, especially approximately 1 Mbit/s. The volume of data to be transmitted for an abstracted model or pose model with 24 data points per second having approximately 20 points per person in the image and x/y coordinates may amount approximately to between 3 and 40 kbit/s, for example, especially approximately 8 kbit/s, per person in the image. The volume of data to be transmitted for an abstracted model or pose model with additional snapshots or individual images at regular intervals, e.g., every 3 to 8 seconds, especially every 5 seconds, may amount approximately to between 3 and 40 kbit/s, for example, especially approximately 8 kbit/s, per person in the image for the abstracted model or pose model and, e.g., approximately between 80 and 120 kbit/s, especially approximately 100 kbit/s, for background images. The values indicated here serve merely as example for a data transmission.

FIG. 3 shows a schematic representation of a vehicle 20 with an abstracted model 52 of a vehicle occupant 24 according to one exemplary embodiment of the present invention. In particular, the limbs of vehicle occupant 24 are represented preferably by the use of lines. In addition, the joints may be represented as nodal points. Preferably, the lines in this advantageous embodiment overlie the body of vehicle occupant 24. In other words, based on the video data, a pose recognition or a pose estimation may be carried out. The data obtained, that is, the abstracted model, represents a person in greatly simplified fashion, especially as a stick figure. The joints of the person may be represented as nodal points, for example. The nodal points preferably include only a small volume of data.

In addition to the abstracted model, different pose data may also be added by snapshots according to FIG. 4, FIG. 5 and/or FIG. 6, and thus be transmitted as single frames, so that further visual clues are available to analyze the situation in the passenger compartment. This is especially helpful when security personnel, who evaluate the data, must assess a potentially dangerous situation.

FIG. 4 shows a schematic representation of a snapshot of a passenger compartment 26 according to one exemplary embodiment of the present invention. For example, the snapshot may be taken utilizing a monitoring device according to FIG. 1 and/or within the method according to FIG. 2. The snapshot may take the form of a single frame, for example. Alternatively or additionally, the snapshot may take the form of a short film sequence.

Preferably, a vehicle occupant 24 and an article 54, here a backpack, are recognized in the snapshot according to FIG. 4. In addition, vehicle occupant 24 and article 54 are localized in such a way that a position area may be assigned to them. Preferably, vehicle occupant 24 is located in a first position area 56 and article 54, thus, backpack 54, is located in a second position area 58. The position areas, thus, first position area 56 and second position area 58, are marked in particular by a dash-lined rectangle. The marking may be inserted into the snapshot with the aid of an algorithm, 0for example.

FIG. 5 shows a schematic representation of a snapshot of a passenger compartment 26 according to one exemplary embodiment of the present invention. For example, the snapshot may be taken utilizing a monitoring device according to FIG. 1 and/or within the method according to FIG. 2. The snapshot may take the form of a single frame, for example. Alternatively or additionally, the snapshot may take the form of a short film sequence. For example, the snapshot may be analyzed according to the snapshot as per FIG. 4.

In the snapshot according to FIG. 5, preferably a vehicle occupant 24 and an article 54, here a cigarette, are recognized. In addition, vehicle occupant 24 and article 54 are localized in such a way that a position area may be assigned to them. Preferably, vehicle occupant 24 is located in a first position area 56 and article 54, thus, cigarette 54, is located in a second position area 58. The position areas, thus, first position area 56 and second position area 58, are marked in particular by a dash-lined rectangle. The marking may be inserted into the snapshot with the aid of an algorithm, for example.

In this distributed configuration, position areas 56, 58 of vehicle occupant 24 and of article 54, thus the cigarette, overlap at least partially, i.e., completely. Thus, the position areas of vehicle occupant 24 and of article 54, thus, the cigarette, overlap by a percentage of at least 30%, especially at least 50%, here specifically 100%. Preferably, article 54, thus the cigarette, or rather second position area 58 of article 54 is located completely in first position area 56. Due to this, in particular an optimal snapshot may be generated, for example, as optimal evidence photo.

FIG. 6 shows a schematic representation of a snapshot of a passenger compartment 26 according to one exemplary embodiment of the present invention. For example, the snapshot according to FIG. 6 may be analyzed according to the snapshot as per FIG. 5. In the snapshot according to FIG. 6, in addition to article 54, preferably smoke 60 may also be detected, which suggests a cigarette 54.

What is claimed is:

1. A method for monitoring a passenger compartment, comprising the following steps:
monitoring a passenger compartment and recognizing a vehicle occupant using a monitoring device;
determining an abstracted model of the vehicle occupant based on data of the monitoring device;
detecting a critical situation in the passenger compartment;
taking one or more snapshots of the critical situation utilizing the monitoring device; and
transmitting the abstracted model of the vehicle occupant and the one or more snapshots to a server, and/or storing the abstracted model of the vehicle occupant and the one or more snapshots in a storage unit and/or initiating a defined action.

2. The method as recited in claim 1, wherein a critical situation is: (i) smoking in the passenger compartment, and/or (ii) a situation injurious to health for one or more vehicle occupants, and/or (iii) violence between two or more vehicle occupants, and/or (iv) stealing of one or more articles in the passenger compartment.

3. The method as recited in claim 1, wherein one or more vehicle occupants and/or one or more articles in the passenger compartment, are classified as different objects using an object classification.

4. The method as recited in claim 1, wherein one or more vehicle occupants and/or one or more articles in the passenger compartment, is localized using the monitoring device.

5. The method as recited in claim 4, wherein a position area of the one or more occupants and/or of the one or more articles in the passenger compartment, is identified.

6. The method as recited in claim 5, wherein the one or more snapshots is made when position areas of the one or more vehicle occupants and/or of the one or more articles in the passenger compartment at least partially overlap.

7. The method as recited in claim 5, wherein the one or more snapshots is made when position areas of the one or more vehicle occupants and/or of the one or more articles in the passenger compartment, overlap by a percentage of at least 30%.

8. The method as recited in claim 7, wherein the percentage is at least 50%.

9. An apparatus for monitoring a passenger compartment, comprising:
a monitoring device;
wherein the apparatus is configured to:
monitor a passenger compartment and recognizing a vehicle occupant using the monitoring device,
determine an abstracted model of the vehicle occupant based on data of the monitoring device,
detect a critical situation in the passenger compartment,
taking one or more snapshots of the critical situation utilizing the monitoring device, and
transmit the abstracted model of the vehicle occupant and the one or more snapshots to a server, and/or store the abstracted model of the vehicle occupant and the one or more snapshots in a storage unit and/or initiate a defined action.
